(19) United States
(12) Patent Application Publication
(10) Pub. No.: US 2012/0021298 A1
(43) Pub. Date: Jan. 26, 2012

(54) ALL-SOLID LITHIUM ION SECONDARY BATTERY AND ELECTRODE THEREFOR

(75) Inventor: Hideaki MAEDA, Osaka (JP)

(73) Assignee: Samsung Electronics Co., Ltd., Suwon-si (KR)

(21) Appl. No.: 13/166,858

(22) Filed: Jun. 23, 2011

(30) Foreign Application Priority Data
Jul. 26, 2010 (JP) 2010-167484
Oct. 11, 2010 (KR) 10-2010-0098826

(51) Int. Cl. H01M 10/056

(52) U.S. Cl. 429/304

(57) ABSTRACT

The positive electrode of a solid lithium ion secondary battery including a solid electrolyte and a positive active material that includes core particles and a coated layer at least partially covering the surfaces of the core particles. The core particles comprise a layered lithium composite oxide including a metal element having an oxidation number that remains constant during charging and discharging within a voltage range from about 2 V to about 5 V. The coated layer comprises a metal compound including a metal element having an oxidation number that remains constant during charging and discharging within a voltage range from about 2 V to about 5 V. The structure of the positive active material is stable over repeated charge and discharge cycles. Interfacial reaction between the positive active material and the solid electrolyte is suppressed. The solid lithium ion secondary battery has high output power and a long lifetime.

### CROSS-REFERENCE TO RELATED APPLICATIONS

This application claims the benefit of Japanese Patent Application No. 2010-167484, filed Jul. 26, 2010 in the Japanese Patent Office, and Korean Patent Application No. 10-2010-0098826, filed Oct. 11, 2010 in the Korean Intellectual Property Office, the disclosures of which are incorporated herein by reference.

### BACKGROUND

1. Field

Aspects of the present disclosure relate to a solid lithium ion secondary battery suitable for use as a battery for electric or hybrid vehicles or as a large-size storage battery, and to an electrode that may be used with the solid lithium ion secondary battery.

2. Description of the Related Art

Recently, solid lithium ion secondary batteries using solid electrolytes with lithium ion conductivity have drawn more attention as higher safety batteries than lithium ion secondary batteries using non-aqueous electrolytes in which lithium salts are dissolved in organic solvents.

Although having good safety characteristics, solid lithium ion secondary batteries generate insufficient output power, since lithium ion conduction takes place between solids. In order to improve low-output power characteristics of solid lithium ion secondary batteries various attempts have been made, for example, to use a thin solid electrolyte layer (U.S. Pat. No. 6,365,300), to use a positive active material including the same kind of anions as that of a solid electrolyte (Japanese Patent Publication No. 2007-324079), and to form a new buffer layer on a surface of a positive active material (Japanese Patent Publication No. 2008-103280).

Interfacial resistance between a positive active material and a solid electrolyte is large and includes contact resistance and reaction resistance between the positive active material and the solid electrolyte.

In solid lithium ion secondary batteries lithium ion exchange reactions (intercalation and deintercalation of lithium ions) take place at points of contact between solids. For this reason, if a positive active material is prone to undergo large structural changes due to intercalation of lithium ions, its lattice spacing may vary during repeated charging and discharging, and its structure may finally become seriously distorted. This leads to a reduced contact area between the positive active material and the solid electrolyte and inhibits migration of lithium ions, increasing interfacial resistance between the positive active material and the solid electrolyte and deteriorating cycle characteristics at high-output operations. In addition, if a solid electrolyte and a positive active material contact each other under unstable conditions, such as when the structure of a positive active material distorts by deintercalation of lithium ions, or when metal compounds of different kinds contact each other, reactions occur at the interface between the positive active material and the solid electrolyte, generating resistance components. This increases interfacial resistance between the positive active material and the solid electrolyte. Therefore, in order to allow for lithium ions to smoothly migrate it is crucial to structurally stabilize positive active materials and, at the same time, to hinder interfacial reactions between positive active materials and solid electrolytes.

### SUMMARY

An aspect of the present invention provides a solid lithium ion secondary battery including a positive active material that is structurally stable even with repeated charging and discharging and having suppressed opportunities for an interfacial reaction between the positive active material and a solid electrolyte.

Another aspect of the present invention provides a positive electrode for a solid lithium ion secondary battery including a positive active material that is structurally stable even with repeated charging and discharging and having suppressed opportunities for an interfacial reaction between the positive active material and a solid electrolyte.

An aspect of the present invention provides a solid lithium ion secondary battery including: a negative electrode incorporating a negative active material that allows for intercalation and deintercalation of lithium ions; a positive electrode incorporating a positive active material that allows for intercalation and deintercalation of lithium ions; and a solid electrolyte between the positive and negative electrodes, wherein the positive electrode includes the positive active material and a solid electrolyte, and the positive active material includes core particles and a coated layer at least partially covering the surfaces of the core particles, and wherein the core particles include a layered lithium composite oxide incorporating a metal element having an oxidation number that remains constant during charging and discharging within a voltage range from about 2 V to about 5 V with a lithium metal counter electrode, and the coated layer includes a metal compound including a metal element having an oxidation number that remains constant during charging and discharging within a voltage range from about 2 V to about 5 V with a lithium metal counter electrode.

Another aspect of the present invention provides a positive electrode for a solid lithium ion secondary battery lithium including a positive active material that allows for intercalation and deintercalation of lithium ions, wherein the positive electrode includes the positive active material and a solid electrolyte, and the positive active material includes core particles and a coated layer at least partially covering the surfaces of the core particles, and wherein the core particles include a layered lithium composite oxide incorporating a metal element having an oxidation number that remains constant during charging and discharging within a voltage range from about 2 V to about 5 V with a lithium metal counter electrode, and the coated layer includes a metal compound including a metal element having a constant oxidation number that remains constant during charging and discharging within a voltage range from about 2 V to about 5 V with a lithium metal counter electrode.

Still another aspect of the present invention provides a positive active material including core particles and a coated layer at least partially covering the surfaces of the core particles, wherein the core particles include a layered lithium composite oxide incorporating a metal element having an oxidation number that remains constant during charging and discharging within a voltage range from about 2 V to about 5 V with a lithium metal counter electrode, and the coated layer includes a metal compound incorporating a metal element having an oxidation number that remains constant during charging and discharging within a voltage range from about 2 V to about 5 V with a lithium metal counter electrode.

The metal element having a constant oxygen number may include at least one metal element selected from the group consisting of aluminum (Al), gallium (Ga), silicon (Si), magnesium (Mg), titanium (Ti), barium (Ba), zirconium (Zr), and yttrium (Y).

The metal compound may include an organic compound, an inorganic compound or a mixture of organic and inorganic compounds. In particular, the metal compound may include at least one element selected from the group consisting of oxygen (O), hydrogen (H), and carbon (C). The metal compound may be a metal alkoxide. The metal compound may be an inorganic oxide. The metal compound may be an amorphous material.

The solid electrolyte may have a lithium ion conductivity of 10⁻⁴ S/cm or greater

The positive active material may include an oxide or sulfide of a transition metal selected from the group consisting of manganese (Mn), cobalt (Co), nickel (Ni), iron (Fe), and aluminum (Al).

Amorphous or crystalline inorganic oxides may be obtained from metal alkoxides by using a sol-gel method, and these materials may be used as the metal compound.

According to some embodiments of the present invention, in the layered lithium composite oxide, a metal element (Me) having an oxidation number (n+) that remains constant during charging and discharging constitutes core particles of the layered lithium composite, and acts as a filler stabilizing the layered structure of the lithium composite oxide. The metal element (Me) may prevent the layered structure from being deformed due to variations in lattice spacing of the positive active material during charging and discharging, and thus maintains contact between the positive active material and the solid electrolyte. Thus, the migration path of lithium ions is ensured between the positive active material and the solid electrolyte, suppressing an increase in contact resistance between solids, i.e., at the interface between the positive active material and the solid electrolyte. In addition, acting as a buffer layer, the coated layer on the surface of the positive active material that includes a metal compound incorporating a metal element that has a consistent oxidation number during charging and discharging may block contact between the core particles of the layered lithium composite oxide and the solid electrolyte. This prevents the positive active material and the solid electrolyte from reacting at the interface thereof to generate resistance components. According to the aspects of the present invention set forth above, both the contact resistance and reaction resistance are suppressed in the interface between the positive active material and the solid electrolyte. This synergistic effect may prevent a rise in the entire interfacial resistance.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates structures of a general positive active material (a) respectively before and after being charged, and those of a positive active material (b) according to an embodiment of the present invention; and

FIG. 2 illustrates interfacial structures of a general positive active material (a) respectively before and after being charged and discharged, and those of a positive active material (b) according to an embodiment of the present invention.

### DETAILED DESCRIPTION

Reference will now be made in detail to the present embodiments of the present invention, examples of which are illustrated in the accompanying drawings. The embodiments are described below, by referring to the figures, in order to explain the present invention by referring to the figures.

Hereinafter, embodiments of solid lithium ion secondary batteries according to embodiments of the present invention will be described in detail.

According to embodiments of the present invention, a solid lithium ion secondary battery includes a positive electrode, a negative electrode, and a solid electrolyte between the positive electrode and the negative electrode.

The positive electrode includes a solid electrolyte that will be described later, and a positive active material including core particles and a coated layer at least partially covering the surfaces of the core particles, wherein the core particles include a layered lithium composite oxide incorporating a metal element having an oxidation number that remains constant when being charged and discharged within a voltage range from about 2 V to about 5 V with a lithium metal counter electrode, and the coated layer includes a metal compound incorporating a metal element having an oxidation number that remains constant during charging and discharging within a voltage range from about 2 V to about 5 V with a lithium metal counter electrode.

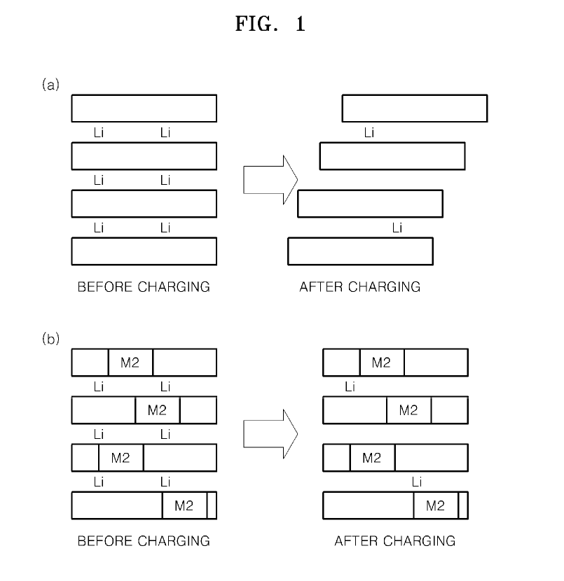

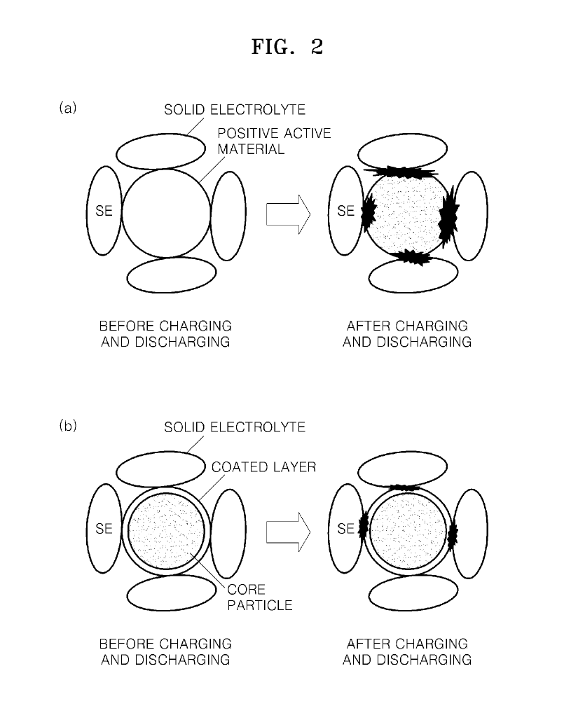

Layered structure compounds such as LiCoO₂ have been widely used as positive active materials for solid lithium ion secondary batteries. However, when LiCoO₂ is used as a positive active material of a solid lithium ion secondary battery, redox reactions of Co may occur with deintercalation of lithium ions during charging, leading to a variation in lattice spacing of the positive active material and deformation of the layered structure, as illustrated in (a) of FIG. 1. Such a deformation in the solid lithium ion secondary battery where a lithium ion exchange takes place between solids may result in a reduced contact area between the positive active material and the solid electrolyte, which does not guarantee sufficient migration paths of lithium ions between the positive active material and the solid electrolyte. In addition, a positive active material such as LiCoO₂ and a solid electrolyte may react at the interface, producing resistance components, as illustrated in (a) of FIG. 2. The resistance components may increase reaction resistance between the positive active material and the solid electrolyte. As described above, the use of a layered structure compound, such as LiCoO₂, as a positive active material of a solid lithium ion secondary battery may increase contact resistance and reaction resistance at the interface between the positive active material and the solid electrolyte with repeated charging and discharging, increasing the entire interfacial resistance.

However, according to aspects of the present invention, as described above, a material having a core-shell structure is used as a positive active material. As illustrated in (b) of FIG. 1, a metal element M2 of the layered lithium composite oxide that has an oxidation number that remains constant during charging and discharging acts as a filler maintaining the lattice spacing of the layered lithium composite oxide that constitutes core particles of the positive active material, and thus stabilizes the layered structure of the positive active material so that it is hard to be deformed even with repeated charging and discharging. This enables the positive active material and the solid electrolyte to be in contact, ensuring sufficient migration paths of lithium ions between the positive active material and the solid electrolyte. As a result, an increase in contact resistance at the interface between the solids, i.e., the positive active material and the solid electrolyte may be suppressed. In addition, as illustrated in (b) of FIG. 2, the core particles of the positive active material are covered by a coated layer that includes the metal compound described above. The coated layer acts as a buffer layer between the core particles of the layered lithium composite oxide and the solid electrolyte to prevent direct contact between the layered lithium composite oxide and the solid electrolyte. This inhibits a reaction at the interface between the positive active material and the solid electrolyte, preventing generation of resistance components. By blocking both the direct contact and the reaction between the positive active material and the solid electrolyte, a rise in the interfacial resistance between the positive active material and the solid electrolyte may be effectively prevented, even with repeated charging and discharging. In FIG. 2, “SE” denotes solid electrolytes.

Suitable layered lithium composite oxides for the core particles include compounds represented by LiNiₓMe1_{y}Me2_{z}O₂, wherein Me1 is selected from among cobalt (Co), iron (Fe), manganese (Mn), and molybdenum (Mo); Me2 is selected from among aluminum (Al), gallium (Ga), silicon (Si), magnesium (Mg), titanium (Ti), barium (Ba), zirconium (Zr), and yttrium (Y); and x+y+z=1. Herein, Me1 and Me2 each may be one metal element or a combination of at least two metal elements. These layered lithium composite oxides may be used individually or in combination of at least two thereof.

Suitable metal compounds for the coated layer include compounds containing metal elements, such as Al, Ga, Si, Mg, Ti, Ba, Zr, or Y. Suitable metal compounds for the coated layer may include these metal elements individually or a combination of at least two thereof.

These metal compounds for the coated layer may include organic compounds (organometallic compounds), inorganic compounds, and mixtures of organic and inorganic compounds. In some embodiments, the metal compound for the coated layer may include a compound including at least one element selected from among O, H, and C.

Suitable metal compounds including at least one of the elements O, H, and C include organic compounds, for example, metal alkoxides, such as metal isopropoxides, metal propoxides, and mixtures of metal isopropoxide and metal propoxide; gels; and amorphous or crystalline inorganic oxides.

Gels, amorphous materials, and crystalline materials as suitable metal compounds for the coated layer may be obtained from the above-listed metal alkoxides by using a sol-gel method. In particular, a metal alkoxide is dissolved in an organic solvent, and is then heated to 60° C. or higher to induce hydrolysis and polycondensation, thereby obtaining an oxide hydrate sol. The oxide hydrate sol is further heated to a temperature of 80-120° C. to evaporate and dehydrate water from the oxide hydrate sol, thereby obtaining a gel compound including O, H, and C. The gel compound may be sintered at a high temperature of 300-600° C. to remove H and C in the forms of H₂O and CO₂ respectively, thereby obtaining an amorphous material. If the sintering is performed at a temperature above 600° C., a crystalline material may be obtained. It is understood that in the metal compounds heated at 120° C. or higher the oxygen element 0 thereof is covalently bonded to metal elements of the core particles. The above-listed metal compounds may be used individually or in combination of at least two thereof.

When the surfaces of the core particles are coated using a sol-gel method, an amount of the added metal alkoxide may be from about 0.01 wt % to about 5.0 wt % on a metal basis with respect to the total amount of the core particles. The amount of the added metal alkoxide (on a metal basis) may be from about 0.1 wt % to 2.0 wt %, and in some embodiments, from about 0.2 wt % to about 0.5 wt %. If the amount of the added metal alkoxide is too small, the coated surface area of the core particles may not be large enough to inhibit the layered lithium composite oxide of the core particles from reacting with the solid electrolyte. On the other hand, if the amount of the added metal alkoxide (on a metal basis) is too large, the coated layer on the core particles may be too thick, and thus may interrupt intercalation and deintercalation of lithium ions between the layered lithium composite oxide of the core particles and the solid electrolyte.

When an inorganic oxide is used as the metal compound for the coated layer, the inorganic oxide may be directly coated on the core particles. In particular, the inorganic oxide is dispersed in an organic solvent, and a dispersion of the core particles is mixed with the inorganic oxide dispersion by using a ball mill. The mixture is heated to evaporate the organic solvent, and is then further heated, thereby obtaining a positive active material coated with the inorganic oxide.

When the surfaces of the core particles are directly coated with an inorganic oxide, an amount of the added inorganic oxide may be from about 0.01 wt % to about 5.0 wt % with respect to the total weight of the core particles. The amount of the added inorganic oxide may be from about 0.02 wt % to about 2.0 wt %, and in some embodiments, from 0.2 wt % to about 2.0 wt %. If the amount of the added inorganic oxide is too small, the surface area of the core particles coated with the inorganic oxide may not be large enough to inhibit the layered lithium composite oxide of the core particles from reacting with the solid electrolyte. On the other hand, if the amount of the added inorganic oxide is too large, the coated layer of the inorganic oxide on the core particles may be too thick, and thus may interrupt intercalation and deintercalation of lithium ions between the layered lithium composite oxide of the core particles and the solid electrolyte.

The coated layer of the positive active material may have a thickness of about 1 nm to about 200 nm. The coated layer may have a thickness of about 5 nm to about 50 nm, and in some embodiments, a thickness of about 5 nm to about 20 nm. If the coated layer is too thin, reaction between the layered lithium composite oxide of the core particles may not be sufficiently prevented. On the other hand, if the coated layer is too thick, intercalation and deintercalation of lithium ions between the layered lithium composite oxide of the core particles and the solid electrolyte may be interrupted.

The surfaces of the core particles of the positive active material may be coated at least partially with the metal compound, and alternatively. However, in some embodiments, the surfaces of the core particles may be entirely coated with the metal compound to further ensure that a reaction between the layered lithium composite oxide of the core particles and the solid electrolyte is prevented.

The positive electrode of the solid lithium ion secondary battery include a positive active material. Any suitable positive active material that allows intercalation and deintercalation of lithium ions may be used. Suitable positive active materials include transition metal-containing oxides and sulfides, wherein the transition metals may include manganese (Mn), cobalt (Co), nickel (Ni), iron (Fe), and aluminum (Al). In some embodiments, suitable positive active materials include LiMn₂O₄, LiCoO₂, LiNiO₂, LiFeO₂, LiNi_{1/3}Co_{1/3}Mn_{1/3}O₂, LiNi_{0.8}Co_{0.2}O₂, and LiNi_{0.8}Co_{0.15}Al_{0.05}O₂. These positive active materials may be used individually or in a combination of at least two thereof.

In the positive electrode an amount of the solid electrolyte may be from about 1 wt % to about 70 wt %. The amount of the solid electrolyte may be from about 5 wt % to about 40 wt %, and in some embodiments, from about 10 wt % to about 35 wt %. If the amount of the solid electrolyte is too small, it is difficult to ensure sufficient migration paths of lithium ions in the positive electrode. On the other hand, if the amount of the solid electrolyte is too large, the capacity per volume of the positive electrode may be too low.

The negative electrode of the solid lithium ion secondary battery includes a negative active material that is alloyable with lithium or may allow for intercalation and deintercation of lithium ions. Suitable negative active materials include metals or metalloids, such as lithium (Li), indium (In), tin (Sn), aluminum (Al), and silicon (Si), and alloys thereof; transition metal oxides, such as Li_{4/3}Ti_{5/3}O₄, and SnO; and carbonaceous materials, such as artificial graphite, graphite carbon fibers, resin-sintered carbon, carbon grown by vapor-phase thermal decomposition, coke, mesophase carbon microbeads (MCMB), furfuryl alcohol resin-sintered carbon, polyacenes, pitch-based carbon fibers (PCF), vapor grown carbon fibers, natural graphite, hard carbon, and the like. These negative active materials may be used individually or in combination of at least two thereof.

The positive and negative electrodes may include mixtures of either the positive or negative active materials in powder form, for example, with electrically conducting agents, binders, fillers, dispersing agents, and ion conductors in appropriate ratios.

Suitable electrically conducting agents include graphite, carbon black, acetylene black, ketjen black, carbon fibers, metal powder, and the like. Suitable binders include polytetrafluoroethylene, polyfluorovinylidene, polyethylene, polypropylene and the like. The positive and negative electrodes may further include, if necessary, a solid electrolyte, which will be described later.

The positive and negative electrodes may be manufactured as follows. In some embodiments, mixtures of active materials and various additives as described above are prepared. Then, the mixtures are respectively compressed into pellets to have high densities by using a hydraulic press, thereby manufacturing the positive and negative electrodes. In some embodiments, the mixtures prepared as described above are added to solvents, for example, water or organic solvents, to obtain slurries or pastes for manufacturing the positive and negative electrodes. Then, these slurries or pastes are respectively coated on current collectors by using, for example, a doctor blade method, are dried, and are then made more dense by using, for example, rolling rolls, thereby manufacturing the positive and negative electrodes.

Suitable current collectors include plates or sheets made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Alternatively, the positive or negative electrode may be manufactured by compressing a positive or negative active material into pellets without using a binder. If a metal or a metal alloy is selected as the negative active material, a metal sheet or a metal alloy sheet may be readily used as the negative electrode without using a current collector.

The solid electrolyte may include a lithium ion conductor as a solid electrolyte, wherein the lithium ion conductor may include an inorganic compound, an organic compound, or a composite material thereof.

Any suitable inorganic compound may be used. Suitable lithium ion conductors include Li₃N, LISICON (lithium super ionic conductors), LIPON (Li_{3+y}PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li₂O—Al₂S₅, and Li₂O—Al₂O₃—TiO₂—P₂O₅ (LATP). These inorganic compounds may have crystalline, amorphous, glass, or glass ceramic structures.

Any suitable organic compound may be used. Suitable organic compounds include polyethylene oxide (PEO), boric acid ester polymers, and the like.

Any suitable inorganic-organic composite material may be used. A suitable inorganic-organic composite material may be a composite of Li₂S—P₂S₅, which is an inorganic solid electrolyte, and polyethylene oxide, which is an organic solid electrolyte.

In some embodiments, the solid electrolyte may have a lithium ion conductivity of 10⁻⁴ S/cm or greater, and in some embodiments, may include a sulfide, such as amorphous Li₂S—P₂S₅, which has a lithium ion conductivity of 10⁻⁴ S/cm or greater.

In some embodiments, a solid lithium ion secondary battery may be manufactured by stacking a positive electrode, a solid electrolyte, and a negative electrode, which are prepared as described above, to form a stack, and then pressing the stack together. In some embodiments, a solid lithium ion secondary battery may be manufactured by depositing or coating a material or composition for forming a positive electrode, a material or composition for forming a solid electrolyte, and a material or composition for forming a negative electrode and then pressing the resultant structure.

### EXAMPLES

The disclosed embodiments will be described in further detail with reference to the following examples. The following examples are for illustrative purposes only and are not intended to limit the scope of the invention.

### Example 1

Layered lithium composite oxide particles of LiNi_{0.8}Co_{0.15}Al_{0.05}O₂ were dispersed in ethanol to obtain a slurry. A solution of aluminum (Al) isopropoxide dissolved in ethanol was added to the slurry until about 0.1 wt % of Al was added with respect to the total weight of the layered lithium composite oxide. Ethanol was evaporated from the mixture at about 100° C. and the resulting product was thermally treated at about 120° C. for about 6 hours to obtain a positive active material.

A mixture of the positive active material, amorphous Li₂S—P₂S₅ (80-20 mol %), and vapor grown carbon fibers (VGCF) in a weight ratio of 60:35:5 was used as a positive electrode composition. A mixture of graphite and amorphous Li₂S—P₂S₅ (80-20 mol %) at a weight ratio of 60:40 was used as a negative electrode composition. Amorphous Li₂S—P₂S₅ (80-20 mol %) synthesized by mechanical milling was used as a material for forming a solid electrolyte. The positive electrode composition, the material for forming a solid electrolyte, and the negative electrode composition were stacked on one another in the order stated, and were then pressed together, thereby manufacturing a solid lithium ion secondary battery.

### Example 2

A solid lithium ion secondary battery was manufactured in the same manner as in Example 1, except that ethanol was evaporated at 60° C. in preparing the positive active material.

### Example 3

A solid lithium ion secondary battery was manufactured in the same manner as in Example 1, except that the thermal treatment was performed at about 300° C. for about 1 hour.

### Example 4

A solid lithium ion secondary battery was manufactured in the same manner as in Example 1, except that titanium isopropoxide was used instead of aluminum isopropoxide.

### Example 5

A solid lithium ion secondary battery was manufactured in the same manner as in Example 1, except that silicon isopropoxide was used instead of aluminum isopropoxide.

### Example 6

A solid lithium ion secondary battery was manufactured in the same manner as in Example 1, except that zirconium isopropoxide was used instead of aluminum isopropoxide.

### Example 7

A solid lithium ion secondary battery was manufactured in the same manner as in Example 1, except that yttrium isopropoxide was used instead of aluminum isopropoxide.

### Example 8

A solid lithium ion secondary battery was manufactured in the same manner as in Example 1, except that the thermal treatment was performed at about 450° C. for about 6 hours.

### Example 9

Layered lithium composite oxide particles of LiNi_{0.8}Co_{0.15}Al_{0.05}O₂ were dispersed in ethanol to obtain a slurry. A solution of aluminum isopropoxide and lithium isopropoxide dissolved in ethanol was added to the slurry until about 0.1 wt % of Al with respect to the total weight of the layered lithium composite oxide and Li was added at an equal mol ratio. Ethanol was evaporated from the mixture at about 120° C., and the resulting product was thermally treated at about 450° C. for about 6 hours to obtain a positive active material. Then, subsequent processes that were the same as in Example 1 were performed, thereby manufacturing a solid lithium ion secondary battery.

### Example 10

Layered lithium composite oxide particles of LiNi_{0.8}Co_{0.15}Al_{0.05}O₂ were dispersed in ethanol to obtain a slurry. A solution of aluminum isopropoxide and magnesium isopropoxide dissolved in ethanol was added to the slurry until about 0.1 wt % of Al and about 0.1 wt % of Mg were added with respect to the total weight of the layered lithium composite oxide. Ethanol was evaporated from the mixture at about 100° C., and the resulting product was thermally treated at about 450° C. for about 6 hours to obtain a positive active material. Then, subsequent processes that were the same as in Example 1 were performed, thereby manufacturing a solid lithium ion secondary battery.

### Example 11

Layered lithium composite oxide particles of LiNi_{0.8}Co_{0.15}Al_{0.05}O₂ and about 0.5 wt % of BaTiO₃ with respect to the amount of the layered lithium composite oxide particles were dispersed in ethanol to obtain a slurry. The slurry was mixed using a planetary ball mill for about 30 minutes. Then, ethanol was evaporated from the mixture at about 100° C., and the resulting product was thermally treated at about 120° C. for about 6 hours to obtain a positive active material. Then, subsequent processes that were the same as in Example 1 were performed, thereby manufacturing a solid lithium ion secondary battery.

### Example 12

Layered lithium composite oxide particles of LiNi_{0.82}Co_{0.15}Mg_{0.03}O₂ were dispersed in ethanol to obtain a slurry. A solution of aluminum (Al) isopropoxide dissolved in ethanol was added to the slurry until about 0.1 wt % of Al was added with respect to the total weight of the layered lithium composite oxide. Ethanol was evaporated from the mixture at about 100° C., and the resulting product was thermally treated at about 450° C. for about 6 hours to obtain a positive active material. Then, subsequent processes that were the same as in Example 1 were performed, thereby manufacturing a solid lithium ion secondary battery.

### Example 13

A solid lithium ion secondary battery was manufactured in the same manner as in Example 1, except that layered lithium composite oxide particles of LiCo_{0.97}Al_{0.03}O₂ were used.

### Example 14

A solid lithium ion secondary battery was manufactured in the same manner as in Example 1, except that layered lithium composite oxide particles of LiNi_{0.82}Co_{0.15}Ti_{0.03}O₂ were used.

### Example 15

A solid lithium ion secondary battery was manufactured in the same manner as in Example 1, except that layered lithium composite oxide particles of LiN_{0.82}Co_{0.15}Ga_{0.03}O₂ were used.

### Example 16

A solid lithium ion secondary battery was manufactured in the same manner as in Example 1, except that layered lithium composite oxide particles of LiNi_{0.82}Co_{0.15}Y_{0.015}Zr_{0.015}O₂ were used.

### Example 17

A solid lithium ion secondary battery was manufactured in the same manner as in Example 1, except that layered lithium composite oxide particles of LiNi_{0.75}Co_{0.1}Mn_{0.1}Al_{0.05}O₂ were used.

### Comparative Example 1

A solid lithium ion secondary battery was manufactured in the same manner as in Example 1, except that layered lithium composite oxide particles of LiNi_{0.8}Co_{0.2}O₂, instead of particles of LiNi_{0.8}Co_{0.15}Al_{0.05}O₂, were used, and surfaces of the layered lithium composite oxide particles were not treated.

### Comparative Example 2

A solid lithium ion secondary battery was manufactured in the same manner as in Comparative Example 1, except that layered lithium composite oxide particles of LiCo₂O₂, instead of particles of LiNi_{0.8}Co_{0.2}O₂, were used.

### Comparative Example 3

LiMn₂O₄ particles were dispersed in deionized water to obtain a slurry. Then, manganese sulfate was added to the slurry until about 0.1 wt % of Mn was added with respect to the total weight of the LiMn₂O₄ particles, and sodium hydroxide was further added, thereby treating the surfaces of the LiMn₂O₄ particles with manganese hydroxide. The surface-treated LiMn₂O₄ particles were thermally treated at about 450° C. for about 6 hours to oxidize manganese hydroxide to obtain manganese oxide, thereby obtaining a positive active material. Then, subsequent processes that were the same as in Comparative Example 1 were performed, thereby manufacturing a solid lithium ion secondary battery.

### Comparative Example 4

LiMn₂O₄ particles were dispersed in deionized water to obtain a slurry. Then, titanium isopropoxide was added to the slurry until about 0.1 wt % of Ti was added with respect to the total weight of the LiMn₂O₄ particles. After being dried, the surface-treated LiMn₂O₄ particles were thermally treated at about 450° C. for about 6 hours to coat the surfaces of the LiMn₂O₄ particles with titanium oxide, thereby obtaining a positive active material. Then, subsequent processes that were the same as in Comparative Example 1 were performed, thereby manufacturing a solid lithium ion secondary battery.

### Comparative Example 5

LiMn₂O₄ particles were dispersed in deionized water to obtain a slurry. Then, cobalt sulfate was added to the slurry until about 0.1 wt % of Co was added with respect to the total weight of the LiMn₂O₄ particles, and sodium hydroxide was further added, thereby treating the surfaces of the LiMn₂O₄ particles with cobalt hydroxide. The surface-treated LiMn₂O₄ particles were thermally treated at about 450° C. for about 6 hours to oxidize cobalt hydroxide to cobalt oxide, thereby obtaining a positive active material. Then, subsequent processes that were the same as in Comparative Example 1 were performed, thereby manufacturing a solid lithium ion secondary battery.

(Performance Test)

The solid lithium ion secondary batteries of Examples 1-17 and Comparative Examples 1 and 2 were charged at a constant current rate of 0.02 C at 25° C. to an upper limit voltage of 4.0 V and discharged at a constant current rate of 0.1 C to a lower cut-off voltage of 2.5 V, to determine capacities of the batteries. An upper limit voltage of 4.2 V was applied when charging the solid lithium ion secondary batteries of Comparative Examples 3-5. The initial charge and discharge cycles were followed by 300 charge and discharge cycles under the same conditions as above. The capacity ratio of the first cycle (initial cycle) to the final cycle was read as a capacity retention rate (%) to evaluate cycle characteristics.

After the first cycle the solid lithium ion secondary batteries were charged under the same condition as in the first cycle and then discharged at a constant current rate of 1 C to measure 1 C capacities. The percentage of the 1 C capacity to the 0.1 C capacity was calculated to evaluate rate characteristics. The results are shown in Table 1 below.

TABLE 1

| | | | | | Performance | |
|---|---|---|---|---|---|---|
| | | | Coated layer | | Rate | Cycle |
| | | Core particles | Metal | Compound | characteristics | characteristics |
| | | Composition | species | species | (%) | (%) |
| Example | 1 | LiNi_{0.8}Co_{0.15}Al_{0.05}O₂ | Al | Alkoxide | 62 | 86 |
| | 2 | LiNi_{0.8}Co_{0.15}Al_{0.05}O₂ | Al | Alkoxide | 60 | 80 |
| | 3 | LiNi_{0.8}Co_{0.15}Al_{0.05}O₂ | Al | Alkoxide + | 63 | 88 |
| | | | | Inorganic oxide | | |
| | 4 | LiNi_{0.8}Co_{0.15}Al_{0.05}O₂ | Ti | Alkoxide | 61 | 84 |
| | 5 | LiNi_{0.8}Co_{0.15}Al_{0.05}O₂ | Si | Alkoxide | 60 | 82 |
| | 6 | LiNi_{0.8}Co_{0.15}Al_{0.05}O₂ | Zr | Alkoxide | 58 | 83 |
| | 7 | LiNi_{0.8}Co_{0.15}Al_{0.05}O₂ | Y | Alkoxide | 51 | 80 |
| | 8 | LiNi_{0.8}Co_{0.15}Al_{0.05}O₂ | Al | Inorganic oxide | 62 | 85 |
| | 9 | LiNi_{0.8}Co_{0.15}Al_{0.05}O₂ | Al—Li | Inorganic oxide | 62 | 85 |
| | 10 | LiNi_{0.8}Co_{0.15}Al_{0.05}O₂ | Mg—Al | Inorganic oxide | 61 | 85 |
| | 11 | LiNi_{0.8}Co_{0.15}Al_{0.05}O₂ | Ba—Ti | Inorganic oxide | 61 | 85 |
| | 12 | LiNi_{0.82}Co_{0.15}Mg_{0.03}O₂ | Al | Inorganic oxide | 62 | 81 |
| | 13 | LiCo_{0.97}Al_{0.03}O₂ | Al | Alkoxide | 62 | 69 |
| | 14 | LiNi_{0.82}Co_{0.15}Ti_{0.03}O₂ | Al | Alkoxide | 57 | 80 |
| | 15 | LiNi_{0.82}Co_{0.15}Ga_{0.03}O₂ | Al | Alkoxide | 61 | 82 |
| | 16 | LiNi_{0.82}Co_{0.15}Y_{0.015}Zr_{0.015}O₂ | Al | Alkoxide | 68 | 88 |
| | 17 | LiNi_{0.75}Co_{0.1}Mn_{0.1}Al_{0.05}O₂ | Al | Alkoxide | 66 | 81 |
| Comparative | 1 | LiNi_{0.8}Co_{0.2}O₂ | — | — | 63 | 49 |
| Example | 2 | LiCoO₂ | — | — | 31 | 11 |
| | 3 | LiMn₂O₄ | Mn | Inorganic oxide | 66 | 58 |
| | 4 | LiMn₂O₄ | Ti | Inorganic oxide | 45 | 33 |
| | 5 | LiMn₂O₄ | Co | Inorganic oxide | 61 | 47 |

Referring to Table 1, the solid lithium ion secondary batteries of Examples 1-17, which were manufactured using the positive active materials including metal elements that do not take part in redox reactions that occur during charging and discharging in the core particles and coated layers are good in terms of both rate characteristics and cycle characteristics. The solid lithium ion secondary batteries of Comparative Examples 1-5 have poor cycle characteristics, suggesting significant rises in interfacial resistance between the positive active materials and the solid electrolytes during repeated charging and discharging. Using LiMn₂O₄ core particles having a spinel structure, the positive active material of Comparative Example 4 was insufficient in terms of both rate characteristics and cycle characteristics, despite having the coated layer including Ti.

As described above, according to the one or more of the above embodiments of the present invention, a solid lithium ion secondary battery uses a positive active material having a structure that is stable with regard to repeated charging and discharging. Due to inhibited interfacial reactions between the positive active material and a solid electrolyte, the solid lithium ion secondary battery may have high output power and a long lifespan.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A solid lithium ion secondary battery comprising:
a negative electrode comprising a negative active material that allows for intercalation and deintercalation of lithium ions;
a positive electrode comprising a positive active material that allows for intercalation and deintercalation of lithium ions; and
a solid electrolyte between the positive and negative electrodes, wherein:
the positive electrode comprises the positive active material and a solid electrolyte, the positive active material comprising core particles and a coated layer at least partially covering the surfaces of the core particles,
the core particles comprise a layered lithium composite oxide including a metal element having an oxidation number that remains constant during charging and discharging within a voltage range from about 2 V to about 5 V with a lithium metal counter electrode, and
the coated layer comprises a metal compound including a metal element having an oxidation number that remains constant during charging and discharging within a voltage range from about 2 V to about 5 V with a lithium metal counter electrode.

2. The solid lithium ion secondary battery of claim 1, wherein the metal element having a constant oxygen number is at least one metal element selected from the group consisting of aluminum (Al), gallium (Ga), silicon (Si), magnesium (Mg), titanium (Ti), barium (Ba), zirconium (Zr), and yttrium (Y).

3. The solid lithium ion secondary battery of claim 1, wherein the metal compound is an organic compound, an inorganic compound or a mixture of organic and inorganic compounds.

4. The solid lithium ion secondary battery of claim 1, wherein the metal compound is at least one element selected from the group consisting of oxygen (O), hydrogen (H), and carbon (C).

5. The solid lithium ion secondary battery of claim 1, wherein the metal compound is a metal alkoxide.

6. The solid lithium ion secondary battery of claim 1, wherein the metal compound is an inorganic oxide.

7. The solid lithium ion secondary battery of claim 1, wherein the metal compound is an amorphous material.

8. The solid lithium ion secondary battery of claim 1, wherein the solid electrolyte has a lithium ion conductivity of 10⁻⁴ S/cm or greater.

9. The solid lithium ion secondary battery of claim 1, wherein the positive active material is an oxide or sulfide of a transition metal selected from the group consisting of manganese (Mn), cobalt (Co), nickel (Ni), iron (Fe), and aluminum (Al).

10. The solid lithium ion secondary battery of claim 1, wherein the negative active material comprises:
a material selected from the group consisting of lithium (Li), indium (In), tin (Sn), aluminum (Al), silicon (Si), and alloys thereof; transition metal oxides; and
carbonaceous materials.

11. A positive electrode for a solid lithium ion secondary battery lithium comprising a positive active material that allows for intercalation and deintercalation of lithium ions, wherein:
the positive electrode comprises the positive active material and a solid electrolyte,
the positive active material comprises core particles and a coated layer at least partially covering the surfaces of the core particles,
the core particles further comprise a layered lithium composite oxide including a metal element having an oxidation number that remains constant during charging and discharging within a voltage range from about 2 V to about 5 V with a lithium metal counter electrode, and
the coated layer comprises a metal compound including a metal element having a constant oxidation number that remains constant during charging and discharging within a voltage range from about 2 V to about 5 V with a lithium metal counter electrode.

12. The positive electrode of claim 11, wherein the metal element having a constant oxidation number is at least one metal element selected from the group consisting of aluminum (Al), gallium (Ga), silicon (Si), magnesium (Mg), titanium (Ti), barium (Ba), zirconium (Zr), and yttrium (Y).

13. The positive electrode of claim 11, wherein the metal compound is an organic compound, an inorganic compound or a mixture of organic and inorganic compounds.

14. The positive electrode of claim 11, wherein the metal compound is at least one element selected from the group consisting of oxygen (O), hydrogen (H), and carbon (C).

15. The positive electrode of claim 11, wherein the metal compound is a metal alkoxide.

16. The positive electrode of claim 11, wherein the metal compound is an inorganic oxide.

17. The positive electrode of claim 11, wherein the metal compound is an amorphous material.

18. The positive electrode of claim 11, wherein the solid electrolyte has a lithium ion conductivity of 10⁻⁴ S/cm or greater.

19. The positive electrode of claim 11, wherein the positive active material is an oxide or sulfide of a transition metal selected from the group consisting of manganese (Mn), cobalt (Co), nickel (Ni), iron (Fe), and aluminum (Al).

20. A positive active material comprising core particles and a coated layer at least partially covering the surfaces of the core particles, wherein:
the core particles further comprise a layered lithium composite oxide including a metal element having an oxidation number that remains constant during charging and discharging within a voltage range from about 2 V to about 5 V with a lithium metal counter electrode, and
the coated layer further comprises a metal compound including a metal element having an oxidation number that remains constant during charging and discharging within a voltage range from about 2 V to about 5 V with a lithium metal counter electrode.
